(19) United States
(12) Patent Application Publication
(10) Pub. No.: US 2004/0246248 A1
(43) Pub. Date: Dec. 9, 2004

(54) Power-saving method for driving light-emitting diode

(75) Inventors: Jason Tsai, Hsinchu (TW); Shih-Ting Chang, Tao Yuan (TW)

Correspondence Address: BRUCE H. TROXELL, SUITE 1404, 5205 LEESBURG PIKE, FALLS CHURCH, VA, 22041, US

(73) Assignee: Holtek Semiconductor Inc.

(21) Appl. No.: 10/732,266

(22) Filed: Dec. 11, 2003

(30) Foreign Application Priority Data
Jun. 3, 2003 (TW) 92114976

(51) Int. Cl. G09G 5/00

(52) U.S. Cl. 345/211

(57) ABSTRACT

The invention is a power-saving method for driving light-emitting diode, and the device employing the method is a matrix display screen that comprises a driving circuit, a memory, and a light-emitting diode. When the display screen performs scanning process, one of the output data and the internal data of the memory is checked. If the data being checked is zero, the execution of scanning a predetermined row of the screen is postponed for one period so that no action is taken. Postponing will achieve a power-saving function for the display screen comprising the light-emitting diode.

### FIELD OF THE INVENTION

The invention relates to a power-saving method for driving light-emitting diode, and in particular, to a method applying to a display screen comprising organic light-emitting diode, wherein the method including the steps of postponing the displaying lines, putting a stop to action, and reducing operating current to provide the power-saving function for the display screen comprising light-emitting diode.

### BACKGROUND OF THE INVENTION

Accordingly, for a portable electronic device that has display screen, for example, movable phone, digital camera, personal digital assistant, etc., the performance of battery has developed to extremity such that, considering the size of battery and convenience of carrying, it is impossible to greatly prolong the usage time of these kinds of electronic device to prevent user from changing battery frequently. For these kinds of display on electronic device, an LCD (i.e., Liquid Crystal Display) in monochrome or multiple colors is mostly adapted. Liquid crystal display is a passive light-emitting element; that is, under the condition of no any other assistant light source, it is uneasy for the user to directly view the pictures shown on LCD, so, under normal usage, LCD must be arranged an assistant light-source device (in general, a small lamp tube), such that the brightness of LCD is increased to deliver an appropriate brightness, but because of such arrangement of assistant light-source device, the power consumption of the electronic device is greatly increased. Therefore, the main point to save the power for this kind of electronic device is to apply an LED (i.e., light-emitting diode) with low power consumption to improve their usage time.

Recently, the industry has developed an innovative LED, which is called OLED (i.e., Organic Light-Emitting Diode) and has the characteristics of actively lighting function and lower power consumption, which may overcome the shortcoming of traditional LCE, and needs assistant power source, so it is extremely possible for OLED to become a mainstream of the display screen for the next generation electronic device.

On monochromatic display screen, it may clearly find that the zone of displaying words or pictures is far less than the zone of displaying nothing so, on this display screen, the power consumption is proportionally higher than that of non-display zone, such that the usage time of electronic device is reduced and the lifetime of battery is shortened because of the less power consumed by the battery. Please refer to FIG. 1, which is a scanning manner of display screen according to prior art, and which includes following steps:

10˜open the power source;

11˜actuate the display screen;

12˜row number of the address of scanning line is equal to N;

13˜activate the scanning line of Nth row, and the Nth row corresponding to the interior of memory outputs data;

14˜accumulate the row number—N=N+1;

15˜close display screen, and the row number is set to zero.

Again, please refer to FIG. 2, which shows that the organic light-emitting diodes are aligned as one row in matrix manner. When the display screen 17 is activated, the organic light-emitting diode drives the circuit by the scanning lines. The scanning process starts and moves sequentially downwards from the first row (horizontal row), and continuous periodically. The corresponding memory 16 provides the necessary data to display. When the sequential number of row is gradually increased, the driving current needed by the display screen 17 must be increased as well. For example, the magnitude of current supplied to the 30^{th} row is the double of the 15^{th} row. Since larger current is needed to supply to the scanning line of larger row number, so the display screen consumes too much unnecessary power.

According to above shortcomings of prior arts, the invention provides a power-saving method for the display screen of an electronic device.

### SUMMARY OF THE INVENTION

Based upon the objective to solve the shortcomings mentioned above in prior arts, the present invention proposes a power-saving method for driving light-emitting diode, and the device employs the method is a matrix display screen comprising a driving circuit, memory, and a light-emitting diode. When the display screen executes scanning process, one of the output data and the internal data of the memory is checked. If the data is zero, then the execution of predetermined row number is postponed for one period, and no action is taken. Postponing the action may provide a power-saving function for the display screen comprising light-emitting diode.

The secondary objective of the invention is to check whether one of the output data and internal data of the memory equal to zero or not. If the data is equal to zero, there is no action executed for the predetermined row number, and the step for lowering down the current is executed and, since the value for executing the row number is decreased, so under the requirement of basic brightness, the ratio between executing row number and entire row number is shown in a decrease relationship, such that the expectation of power-saving function for the display screen comprising the light-emitting diode is achieved.

### BRIEF DESCRIPTION OF THE DRAWINGS

FIG. 1 is an execution flowchart for the scanning method of a display screen according to prior arts.

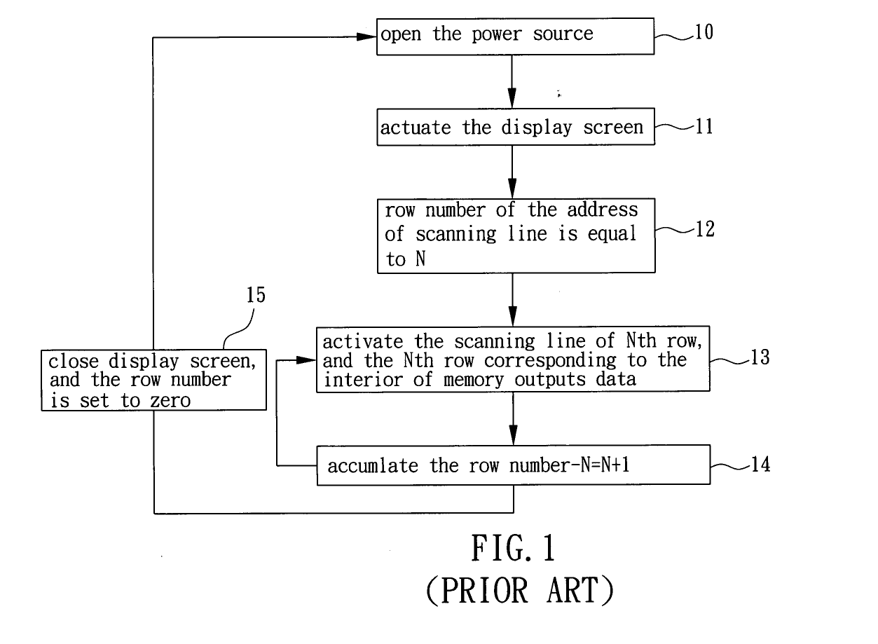

FIG. 2 is an execution illustration for the internal data of a memory output correspondingly to a display screen according to prior arts.

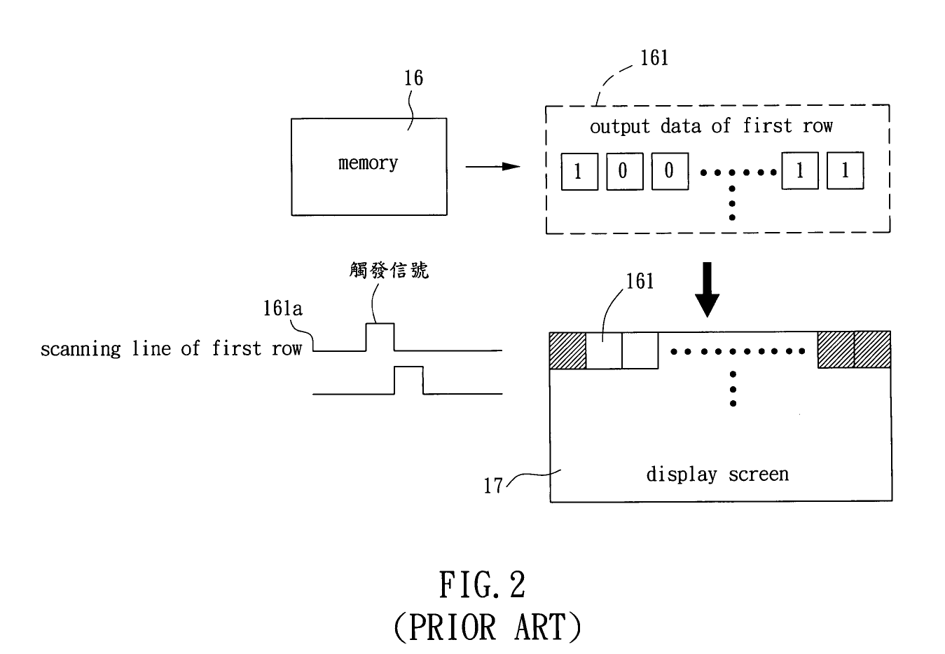

FIG. 3 is the first execution flowchart for the power-saving method for driving a light-emitting diode according to the present invention.

FIG. 4 is the first execution illustration for the internal data of a memory output correspondingly to a display screen according to the present invention.

FIG. 5 is the second execution flowchart for the power-saving method for driving a light-emitting diode according to the present invention.

FIG. 6 is the second execution illustration for the internal data of a memory output correspondingly to a display screen according to the present invention.

### DETAILED DESCRIPTION OF THE INVENTION

For facilitating your esteemed member of reviewing committee in understanding the invention, a detailed structure cooperating with following drawings together with its connective relationship is presented as follows.

The First Preferable Embodiment:

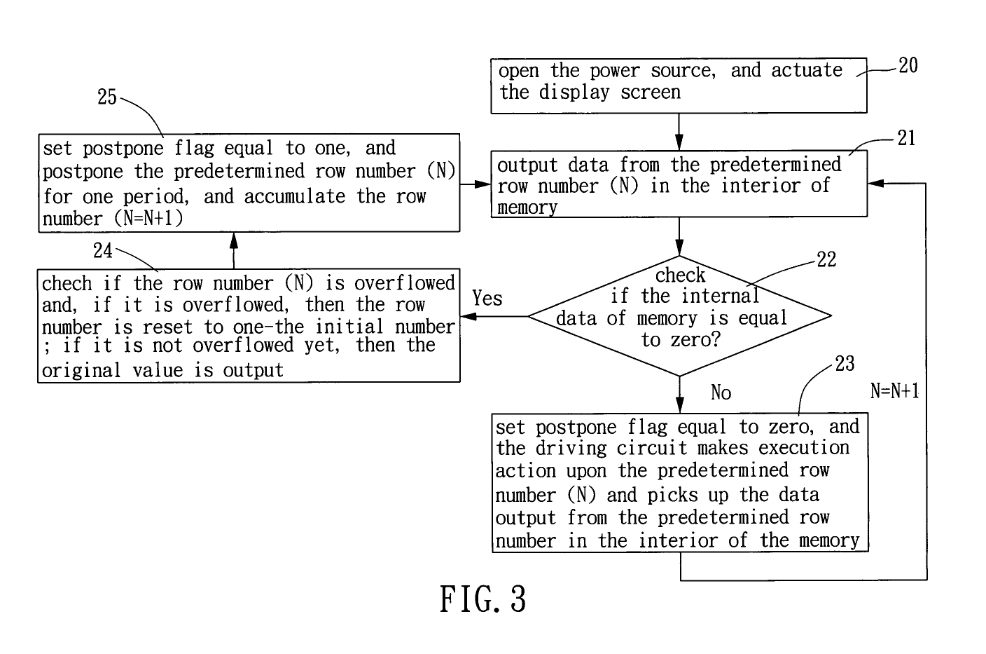

Please refer to FIG. 3, which is the first execution flowchart for the power-saving method for driving the light-emitting diode according to the present invention. The device employing the method includes a matrix display screen comprising a driving circuit, memory, and light-emitting diode. This structure is disclosed by the technical means according to prior arts, so a repetitious description is not presented herein. After this display screen comprising light-emitting diode is powered on, a power-saving function is executed according to following steps:

20˜open the power source, and actuate the display screen;

21˜output data from the predetermined row number (N) in the interior of memory;

22˜check if the internal data of memory is equal to zero? If the checked data is equal to zero, then go to step 24; if the checked data is not equal to zero, then go to step 23;

23˜set postpone flag equal to zero, and the driving circuit makes execution action upon the predetermined row number (N) and picks up the data output from the predetermined row number in the interior of the memory and, after this step is executed, go back to step 21;

24˜set postpone flag equal to one, and postpone the predetermined row number (N) for one period, and accumulate the row number (N=N+1) and, after this step is executed and the row number is accumulated (N=N+1), go back to step 21;

25˜chech if the row number (N) is overflowed and, if it is overflowed, then the row number is reset to one—the initial number; if it is not overflowed yet, then the original value is output.

Except for organic light-emitting diode (abbreviated as OLED), the aforementioned display screen may also comprises general light-emitting diode (abbreviated as LED) or vacuum fluorescence display (abbreviated as VFD) and other general matrix type display screen rowed up by lighting elements as well. All these examples are executable in present invention.

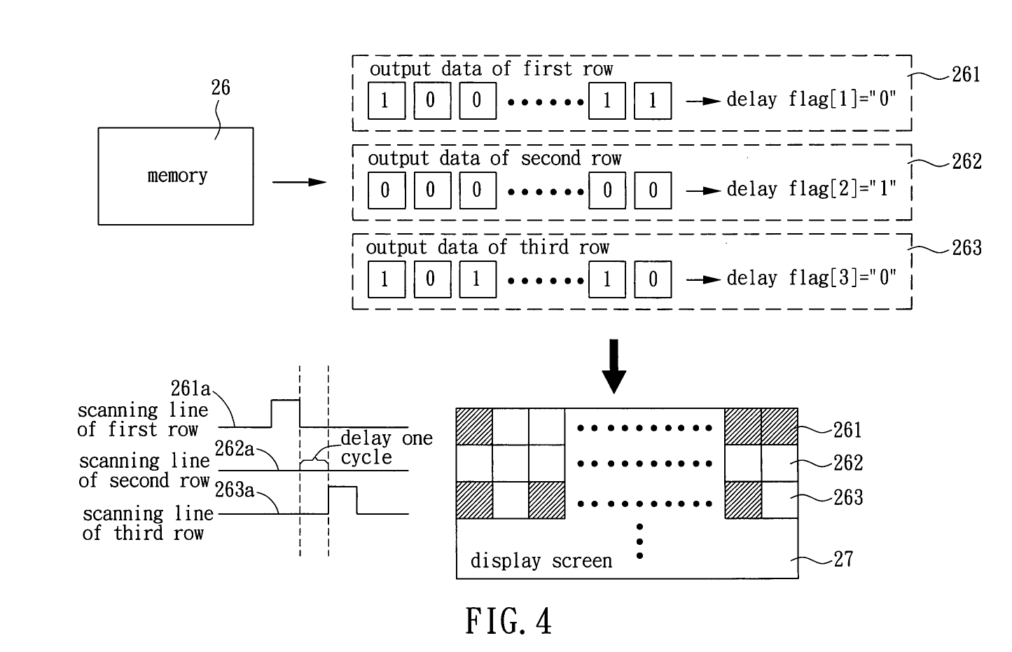

Please refer to FIG. 4, which is the first execution illustration for the internal data of a memory output correspondingly to a display screen according to the invention, wherein data is output from the predetermined row number (N) in the interior of a memory 26. In present embodiment, the values of output data of first row 261 and output data of third row 263 are all not equal to zero, so both of the postpone flags are set to zero. This means that both data will all be output upon one display screen 27; on the contrary, if the value of output data of second row 262 is equal to zero and its postpone flag is set to one, the data will not be output upon the display screen 27.

If the scanning line of first row 261a and the scanning line of third row 263a all generate a touching off signal constructed by square wave, both the scanning line of first row 261a and the scanning line of third row 263a are data stored in memory and output by a driving circuit. On the contrary, except for no action, the signal of the scanning line of second row 262a is postponed for one period. Similarly, the predetermined row numbers, of which all the row data are not stored in the memory and the corresponding flags are set to one, will not be displayed on the display, so the power consumed by these non-displayed row numbers will be saved, and the power-saving objective proclaimed by the invention for the display screen comprised of light-emitting diode is achieved.

The Second Preferable Embodiment:

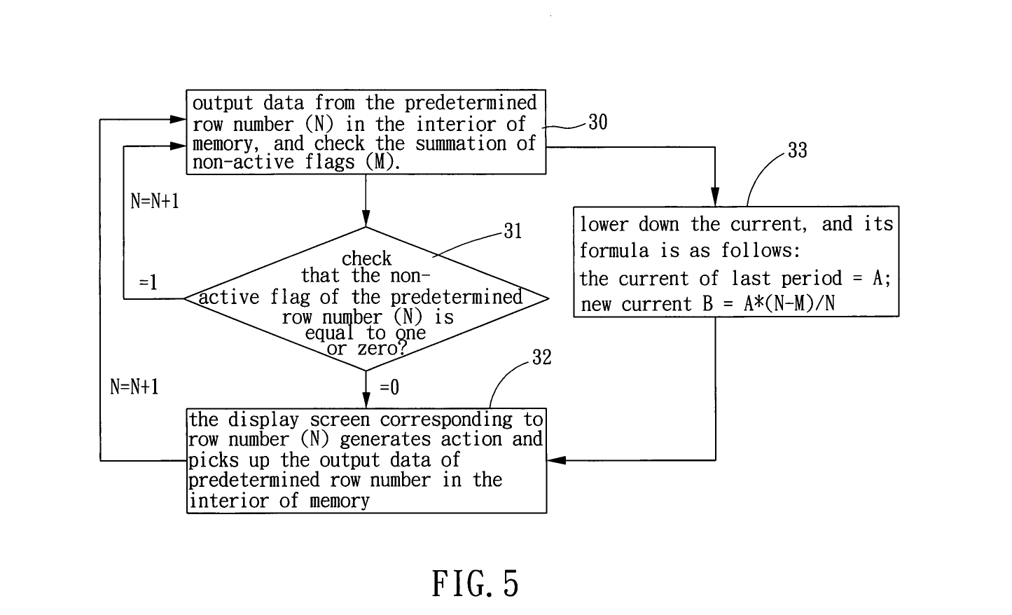

Please refer to FIG. 5, which is the second execution flowchart for the power-saving method for driving the light-emitting diode according to the invention. The device employing the method includes a matrix display screen comprising a driving circuit, memory, and light-emitting diode. After this display screen is powered on, a power-saving function is provided according to following steps:

30˜output data from the predetermined row number (N) in the interior of memory, and check the summation of non-active flags (M).

31˜check whether the non-active flag of the predetermined row number (N) is equal to one or zero. If the value is equal to one then, after the row number is accumulated (N=N+1), the execution goes back to the step 30; if the value is equal to zero, then the step 32 is executed first, and the row number is accumulated secondly (N=N+1), and the execution goes back to the step 30 again.

32˜the display screen corresponding to the row number (N) activates and picks up the output data of the predetermined row number in the interior of memory.

33˜lower down the current, and its formula is as follows:

The current of last period=A;

New current B=A*(N−M)/N.

The reduced value of new current in above formula is that the current of last period times the ratio between the active row number and the summation of the row number of total scanning lines, and the driving circuit adjusts the current to a new value to be further output upon the display screen 35.

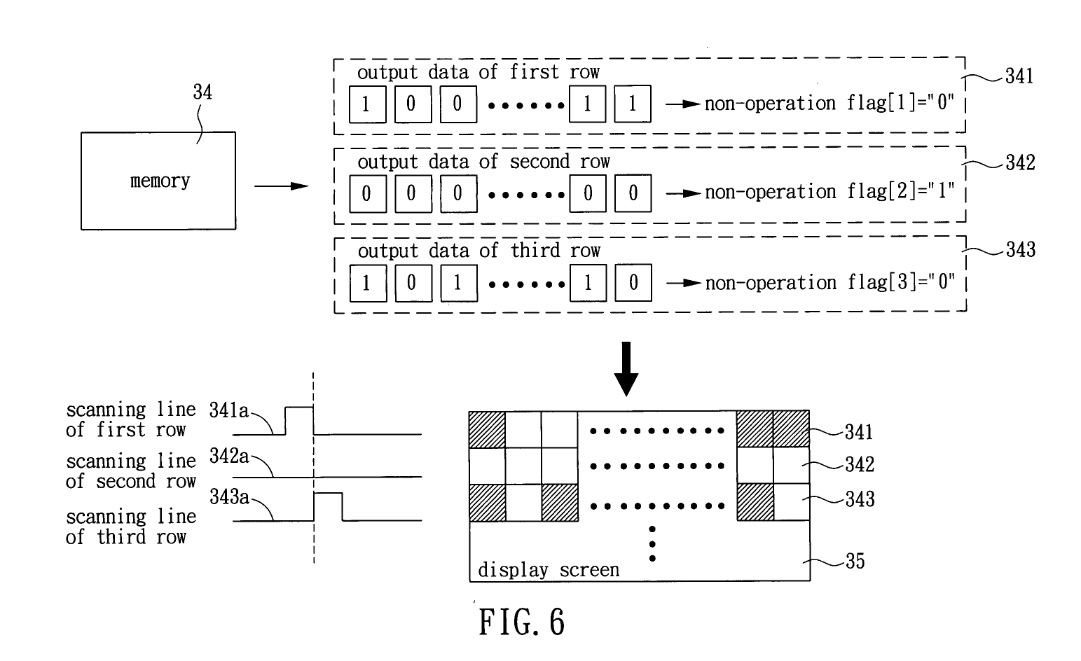

Please refer to FIG. 6, which is the second execution illustration for the internal data of a memory output correspondingly to a display screen according to the invention, wherein data is output from the predetermined row number (N) in the interior of a memory 34. In the present embodiment, the values of the output data of first row 341 and the output data of third row 343 are all not equal to zero, so the postpone flags of both are set to zero. This means that both data will all be output onto the display screen 35; on the contrary, if the value of output data of second row 342 is equal to zero and its postpone flag is set to one, then the data will not be output onto the display screen 35.

The major difference between this drawing and FIG. 4 is that: after executing the steps of FIG. 5, the scanning line of the second row 342a is not activated, and its signal is not postponed for one period either, but its output data is the remained value of the flag set in the last period, so during the procedure of displaying its touching off signal upon the display screen 35, it is completely a continuous touching off signal between the scanning line of the first row 341a and the scanning line of the third row 343a, and it is completely not influenced by the non-action of the scanning line of second row 342a, so it may save more power than the method disclosed in the first preferable embodiment.

Except for non-action of row number and no output data, the invention further adds a mechanism for lowering down the current. In the step 33, it is assumed that the total row number of scanning lines on the display screen 35 is N. After executing the method disclosed in FIG. 5, the number of its total non-displaying row number is M. The current maintaining each scanning line of row number is a constant, so, after the number of active scanning line is reduced, the current for each action of row number must be lowered down subsequently. Therefore, there won't be too large current passing the entire screen to increase entire brightness, so it may lower down the current. On the other hand, after lowering down the current, it may also reduce the noise magnification caused by the larger current to make the circuit more stable; furthermore, the life of usage of light-emitting diode may also be prolonged, since the current is always maintained in an appropriate low level.

In summary, the characteristics and each preferable embodiment according to the present invention have already been disclosed in detail to sufficiently show that the invention deeply has progressiveness in both objective and function, so the invention extremely has application value for industry and has not been seen in current market. According to the spirits described by the patent law, the invention is completely fulfilled the merits of a patent.

However, the aforementioned description is only preferable embodiment of the invention and is not, of course, the limitation of scope for executing the invention, so any equivalent variation and modification made according to the appended claims of the invention are all belonged to the range covered by the invention. Please your esteemed members of reviewing committee grant the present application as a formal patent in favorable way as soon as possible.

What is claimed is:

1. A power-saving method for driving light-emitting diode, the device employing the method is a matrix display screen that comprises a driving circuit, memory, and a light-emitting diode, when a power source of the matrix display screen is actuated, the power-saving function works according to the following steps:
(A) Output data from a predetermined row number (N) in the interior of the memory;
(B) Check whether the internal data of the memory equal to zero;
(C) Set postpone flag to zero, and the driving circuit performs a execution action on a predetermined row number (N) and picks up output data of the predetermined row number (N) in the interior of the memory;
(D) Set postpone flag to one, and postpone the predetermined row number (N) for one period; and
(E) Check whether the row number (N) is overflowed? If overflowed, the row number is reset to 1, which is an initial value; if not, an original value is output.

2. The power-saving method for driving light-emitting diode according to claim 1, wherein if a result of step (B) is positive, the step (D) is executed; if the result of step (B) is negative, the step (C) is executed.

3. The power-saving method for driving light-emitting diode according to claim 1, wherein after the step (C) is executed, the row number is added by one (i.e., N=N+1), then the execution goes back to the step (A).

4. The power-saving method for driving light-emitting diode according to claim 1, wherein after the step (D) is executed, the row number is added by one (i.e., N=N+1), then the execution goes back to the step (A).

5. The power-saving method for driving light-emitting diode according to claim 1, wherein the memory is a static random accessing memory (abbreviated as SRAM).

6. The power-saving method for driving light-emitting diode according to claim 1, wherein the memory is a dynamic random accessing memory (abbreviated as DRAM).

7. The power-saving method for driving light-emitting diode according to claim 1, wherein the light-emitting diode is an organic light-emitting diode (abbreviated as OLED).

8. The power-saving method for driving light-emitting diode according to claim 1, wherein the light-emitting diode is a vacuum fluorescence display (abbreviated as VFD).

9. The power-saving method for driving light-emitting diode according to claim 1, wherein the light-emitting diode is a light-emitting diode (abbreviated as LED).

10. A power-saving method for driving light-emitting diode, a device employing the method is a matrix display screen comprising a driving circuit, memory, and a light-emitting diode, when a power source of the matrix display screen is actuated, the power-saving function is provided according to the following steps:
(a) Output data from a predetermined row number (N) in the interior of the memory, and check a summation of non-active flags;
(b) Check whether the non-active flag of the predetermined row number (N) equal to one or zero;
(c) Display a screen generating action corresponding to the row number (N) and picks up output data of the predetermined row number in the interior of the memory; and
(d) Apply the ratio relationship among the current (A) of last period, the new current (B), the row number (N), and the summation of non-active flags (M) to lower down the current.

11. The power-saving method for driving light-emitting diode according to claim 10, wherein the formula for lowering down the current in step (d) is as follows:
Given that the current of last period is A, then the new current B=A*(N−M)/N; and a reduced value of a current is obtained that the current of last period times a ratio between a active row number and a summation of a total row number of lines being scanned, and the driving circuit adjusts the current to a new value to output to the display screen.

12. The power-saving method for driving light-emitting diode according to claim 10, wherein if the value in the step (b) is equal to one, then the row number is added by one (i.e., N=N+1), and the execution goes back to the step (a).

13. The power-saving method for driving light-emitting diode according to claim 10, wherein if the value in the step (b) is equal to zero, then the step (c) is executed first, and the row number is added by one (i.e., N=N+1), and the execution goes back to the step (a) to continue the execution.

14. The power-saving method for driving light-emitting diode according to claim 10, wherein the memory is a static random accessing memory (abbreviated as SRAM).

15. The power-saving method for driving light-emitting diode according to claim 1, wherein the memory is a dynamic random accessing memory (abbreviated as DRAM).

16. The power-saving method for driving light-emitting diode according to claim 1, wherein the light-emitting diode is an organic light-emitting diode (abbreviated as OLED).

17. The power-saving method for driving light-emitting diode according to claim 1, wherein the light-emitting diode is a vacuum fluorescence display (abbreviated as VFD).

18. The power-saving method for driving light-emitting diode according to claim 1, wherein the light-emitting diode is a light-emitting diode (abbreviated as LED).
